(19) United States
(12) Patent Application Publication
(10) Pub. No.: US 2020/0316837 A1
(43) Pub. Date: Oct. 8, 2020

(54) Nozzle Heater

(71) Applicant: Synventive Molding Solutions, Inc., Peabody, MA (US)

(72) Inventors: Sebastian Markus Kraus, Bensheim (DE); Gerald Kredel, Winterkasten (DE)

(21) Appl. No.: 16/505,923

(22) Filed: Jul. 9, 2019

Related U.S. Application Data
(60) Provisional application No. 62/828,102, filed on Apr. 2, 2019.

(51) Int. Cl. B29C 45/74; B29C 45/78

(52) U.S. Cl. CPC B29C 45/74; B29C 2945/7621; B29C 2945/7604; B29C 45/78

(57) ABSTRACT

A heating apparatus (5) in an injection molding apparatus (1000) comprising:
a heatable sleeve or jacket (10) comprised of a sheet (14) of highly heat conductive metal material, formable into a heating cylinder (14c) having a central channel (16) receiving a selected nozzle (40),
a stabilization ring or cylinder (20) adapted to receive a selected longitudinal portion (DL) of the downstream or distal end (14de) of the heating cylinder (14c) and to engage or mate an inner circumferential surface (20is) with an outer surface (14os) of the heating cylinder.

### RELATED APPLICATIONS

This application claims the benefit of priority of U.S. provisional application Ser. No. 62/828,102 filed Apr. 2, 2019, the disclosure of which is incorporated by reference as if fully set forth in its entirety herein.

The disclosures of all of the following are incorporated by reference in their entirety as if fully set forth herein: U.S. Pat. Nos. 5,894,025, 6,062,840, 6,294,122 (7018), U.S. Pat. Nos. 6,309,208, 6,287,107, 6,343,921, 6,343,922, 6,254,377, 6,261,075, 6,361,300 (7006), U.S. Pat. Nos. 6,419,870, 6,464,909 (7031), U.S. Pat. No. 6,062,840 (7052), U.S. Pat. No. 6,261,075 (7052US1), U.S. Pat. Nos. 6,599,116, 7,234,929 (7075US1), U.S. Pat. No. 7,419,625 (7075US2), U.S. Pat. No. 7,569,169 (7075US3), U.S. Pat. No. 8,297,836 (7087) U.S. patent application Ser. No. 10/214,118, filed Aug. 8, 2002 (7006), U.S. Pat. No. 7,029,268 (7077US1), U.S. Pat. No. 7,270,537 (7077US2), U.S. Pat. No. 7,597,828 (7077US3), U.S. patent application Ser. No. 09/699,856 filed Oct. 30, 2000 (7056), U.S. patent application Ser. No. 10/269,927 filed Oct. 11, 2002 (7031), U.S. application Ser. No. 09/503,832 filed Feb. 15, 2000 (7053), U.S. application Ser. No. 09/656,846 filed Sep. 7, 2000 (7060), U.S. application Ser. No. 10/006,504 filed Dec. 3, 2001, (7068), U.S. application Ser. No. 10/101,278 filed Mar. 19, 2002 (7070) and PCT Application No. PCT/US11/062099 (7100WO0) and PCT Application No. PCT/US11/062096 (7100WO1), U.S. Pat. Nos. 8,562,336, 8,091,202 (7097US1) and U.S. Pat. No. 8,282,388 (7097US2), U.S. Pat. No. 9,724,861 (7129US4), U.S. Pat. No. 9,662,820 (7129US3), Publication No. WO2015006261 (7135WO0), Publication No. WO2014209857 (7134WO0), Publication No. WO2016153632 (7149WO2), International publication no. WO2016153704 (7149WO4), U.S. Pat. No. 9,205,587 (7117US0), U.S. application Ser. No. 15/432,175 (7117US2) filed Feb. 14, 2017, U.S. Pat. No. 9,144,929 (7118US0), U.S. Publication No. 20170341283 (7118US3), International Application WO2017214387 (7163WO0), International Application PCT/US17/043029 (7165WO0) filed Jul. 20, 2017, International Application PCT/US17/043100 (7165WO1), filed Jul. 20, 2017 and International Application PCT/US17/036542 (7163WO0) filed Jun. 8, 2017 and International Application WO2018129015 (7169WO0)

### BACKGROUND OF THE INVENTION

Heating devices for controllably delivering heat to a fluid passage device such as a downstream nozzle that routes injection fluid from a heated manifold or other source in an injection molding apparatus have been used in a variety of forms such as disclosed in E.P.O. Patent No. 1051059(B1).

### SUMMARY OF THE INVENTION

In accordance with the invention there is provided a heating apparatus (5) in an injection molding apparatus (1000) comprised of an injection molding machine (500) that injects injection fluid (1018) to a heated manifold (1039) that distributes the injection fluid (1018) to one or downstream nozzles (40, 1020, 1024), the heating apparatus (5) comprising:

a heatable sleeve or jacket (10) comprised of a sheet (14) of highly heat conductive metal material, the sheet or jacket having opposing sheet edges, the sheet or jacket being bendable or formable into a heating cylinder (14c) having a central channel (16) having an interior circumferential wall surface (14is) and a selected longitudinal length (JL) extending from a downstream end (14de) to an upstream end (14ue) of the heating cylinder (14c),

the central channel (16) being formed into a configuration wherein a selected nozzle (40) is received within the central channel (16) and the interior circumferential wall surface (14is) of the channel engages an outer circumferential wall surface (40os) of the selected nozzle (40),

the sheet (14) having opposing sheet edges (14r, 14l) that are disposed in a select arrangement or position relative to each other upon bending or forming of the sheet (14) into the cylinder (14c) and reception of the selected nozzle (40) within the central channel (16),

a stabilization ring or cylinder (20) having a central ring channel (20cc) having an inner ring circumferential surface (20is), the stabilization ring or cylinder (20) being adapted to receive a selected longitudinal portion (DL) of the downstream or distal end (14de) of the heating cylinder (14c),

the stabilization ring or cylinder (20) being adapted to engage or mate the inner ring circumferential surface (20is) with an outer surface (14os) of the heating cylinder (14) extending along the selected longitudinal portion (DL) of the downstream or distal end (14de) of the heating cylinder (14c).

Such an apparatus can include a wire or coil (12) that is controllably heatable to an elevated temperature and that is mounted in heat conductive communication (12e) with the heating cylinder (14).

The highly heat conductive metal material of which the heatable sleeve or jacket is comprised typically comprises one or more of a copper, brass, zinc. The highly heat conductive metal material can be comprised of at least about 90% by weight of one or more or a mixture of brass, copper and zinc.

The wire or coil (12) is typically embedded (12e) within a groove (14g) formed within the heating cylinder (14c).

A temperature measuring sensor (18) is typically mounted on the downstream or distal end (14de) of the heating cylinder (14c) in thermal isolation (16) from the wire or coil (12, 12e).

The opposing sheet edges (14r, 14l) can be interconnected or attached (14at) to each other after formation of the heating cylinder (14c). Alternatively the opposing sheet edges (14r, 14l) can remain unconnected or unattached once the heating cylinder (14c) is formed.

The apparatus can include an upstream sleeve or jacket (30) having an extended receiving aperture (30a) having an extended longitudinal length (JL) and interior extended jacket surface (30is), the upstream sleeve or jacket (30) being adapted to receive an upstream end or portion (14ue) of the heater cylinder (14c) along the extended longitudinal length (JL), the upstream sleeve or jacket (30) being further adapted such that the interior extended jacket surface (30is) engages an outer circumferential surface (14os) of the upstream end or portion (14ue) of the heater cylinder (14c).

The stabilization ring or cylinder (20) can be adapted to be compressed (F) around an outer circumferential surface (20ca) into a fixedly formed or deformed body (20db) having a body size that is preselected such that the inner circumferential surface (20is) of the stabilization ring or cylinder (20, 20db) is compressibly engaged with the outer circumferential surface (40os) of the downstream or distal end (14de) of the heating cylinder (14c)

The inner circumferential ring surface (20is) and the outer circumferential surface (14os) typically extend along at least a portion of the downstream or distal longitudinal length (DL) of the downstream or distal end (14de) of the heater cylinder (14c) have complementary threads (14t, 20t) adapted to threadably engage and interconnect with each other.

The stabilization ring or cylinder (20) is typically comprised of an iron containing metal material such as steel or stainless steel, typically comprised of at least about 95% steel or iron.

The apparatus can further comprise a temperature measuring sensor (18o) mounted on or in the nozzle (40) or a nozzle mount (40ni) in close adjacency to the outer surface (14os) of the downstream or distal end (14de) of the heater cylinder (14c).

In another aspect of the invention there is provided a heating apparatus (5) in an injection molding apparatus (1000) comprised of an injection molding machine (500) that injects injection fluid (1018) to a heated manifold (1039) that distributes the injection fluid (1018) to one or downstream nozzles (40, 1020, 1024), the heating apparatus (5) comprising:

a heatable sleeve or jacket (10) comprised of a sheet (14) of highly heat conductive metal material, the sheet or jacket having opposing sheet edges, the sheet or jacket being bendable or formable into a heating cylinder (14c) having a central channel (16) having an interior circumferential wall surface (14is) and a selected longitudinal length (JL) extending from a downstream end (14de) to an upstream end (14ue) of the heating cylinder (14c),

the central channel (16) being formed into a configuration wherein a selected nozzle (40) is received within the central channel (16) and the interior circumferential wall surface (14is) of the channel engages an outer circumferential wall surface (40os) of the selected nozzle (40),

the sheet (14) having opposing sheet edges (14r, 14l) that are disposed in a select arrangement or position relative to each other upon bending or forming of the sheet (14) into the cylinder (14c) and reception of the selected nozzle (40) within the central channel (16),

a stabilization ring or cylinder (20) having a central ring channel (20cc) having an inner ring circumferential surface (20is), the stabilization ring or cylinder (20) being adapted to receive a selected longitudinal portion (DL) of the downstream or distal end (14de) of the heating cylinder (14c),

the stabilization ring or cylinder (20) being adapted to engage the inner ring circumferential surface (20is) around an outer circumferential surface (14os) of the heating cylinder extending along a predetermined length (PDL) of all or a portion of the selected longitudinal portion (DL) that is selected such that the opposing sheet edges (14r, 14l) are held in fixed position (14rf, 141f) relative to each other along at least a selected portion (SPL, SPL1, SPL2, SPL3) of the longitudinal length (HL) of the heating cylinder (14c) extending from the downstream end (14de) toward the upstream end (14ue).

The predetermined length (PDL) of all or a portion of the selected longitudinal portion (DL) is preferably selected such that the opposing sheet edges (14r, 14l) are held disconnected or unattached in fixed position (14rf, 141f) relative to each other along at least the selected portion (SPL, SPL1, SPL2, SPL3) of the longitudinal length (HL) of the heating cylinder (14c) extending from the downstream end (14de) toward the upstream end (14ue).

The longitudinal length of the selected longitudinal portion (DL) of the downstream or distal end (14de) of the heating cylinder (14c) can be selected such that the opposing sheet edges (14r, 14l) are held disconnected or unattached in the fixed position (14rf, 141f) relative to each other along the entire longitudinal length (HL) of the heating cylinder (14c).

Such an apparatus can include a wire or coil (12) that is controllably heatable to an elevated temperature and that is mounted in heat conductive communication (12e) with the heating cylinder (14).

The wire or coil (12) can be embedded (12e) within a groove (14g) formed within the heating cylinder (14c).

The apparatus can include a temperature measuring sensor (18) such as a thermocouple mounted on the downstream or distal end (14de) of the heating cylinder (14c) in thermal isolation (16) from the wire or coil (12, 12e).

The opposing sheet edges (14r, 14l) can be interconnected or attached (14at) to each other after formation of the heating cylinder (14c). Such attachment mechanisms (14at) can comprise one or more of a clasp, a wire, a weld, a clip or the like.

Such an apparatus can further comprise an upstream sleeve or jacket (30) having an extended receiving aperture (30a) having an extended longitudinal length (JL) and interior extended jacket surface (30is), the upstream sleeve or jacket (30) being adapted to receive an upstream end or portion (14ue) of the heater cylinder (14c) along the extended longitudinal length (JL), the upstream sleeve or jacket (30) being further adapted such that the interior extended jacket surface (30is) engages an outer circumferential surface (14os) of the upstream end or portion (14ue) of the heater cylinder (14c).

The stabilization ring or cylinder (20) can be adapted to be compressed (F) around an outer circumferential surface (20ca) into a fixedly formed or deformed body (20db) having a body size such that the inner circumferential surface (20is) of the stabilization ring or cylinder (20, 20db) is compressibly engaged with the outer circumferential surface (40os) of the downstream or distal end (14de) of the heating cylinder (14c)

The inner circumferential ring surface (20is) and the outer circumferential surface (14os) extending along at least a portion of the downstream or distal longitudinal length (DL) of the downstream or distal end (14de) of the heater cylinder (14c) can have complementary threads (14t, 20t) adapted to threadably engage and interconnect with each other.

The stabilization ring or cylinder (20) can be comprised of an iron containing material.

The apparatus can further comprising a temperature measuring sensor (180) mounted on or in the nozzle (40) or a nozzle mount (40ni) in close adjacency to the outer surface (14os) of the downstream or distal end (14de) of the heater cylinder (14c).

### BRIEF DESCRIPTION OF THE DRAWINGS

The above and further advantages of the invention may be better understood by referring to the following description in conjunction with the accompanying drawings in which:

FIG. 1A is a top view of one of two opposing sides of a sheet form heating sleeve element of a heating apparatus according to the invention.

FIG. 1B is a front perspective view of the sheet form heating sleeve element of FIG. 1A formed into a cylindrical configuration.

FIG. 10 is a rendering of the sequential process by which a heating apparatus according to the invention is formed from the interconnection of a sheet form heating sleeve element as shown in FIGS. 1A, 1B and a distal end fastening cylinder.

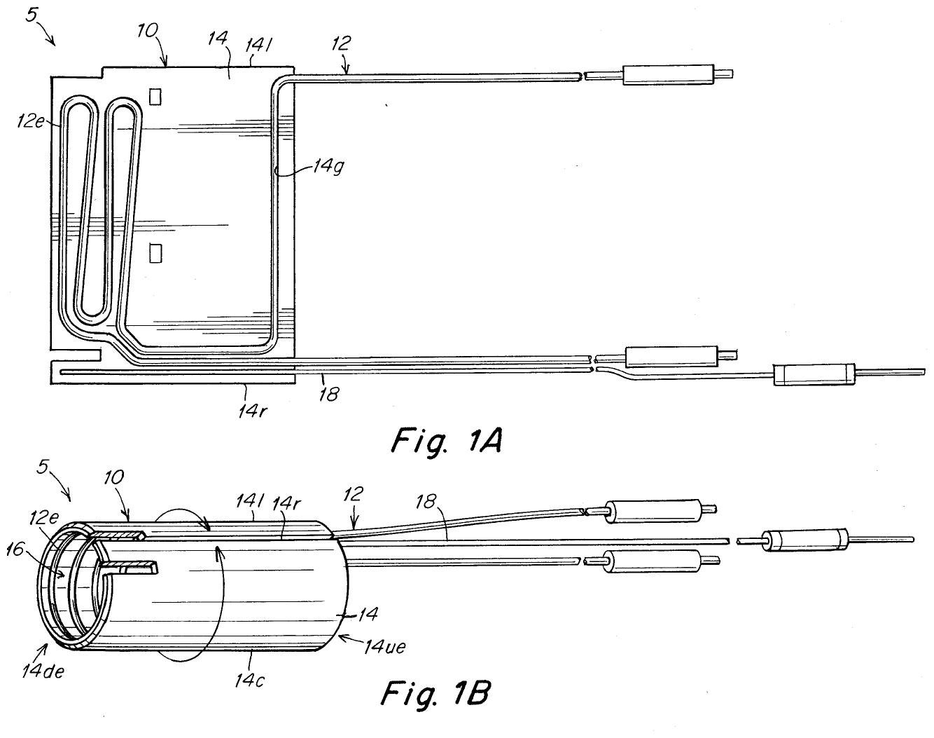

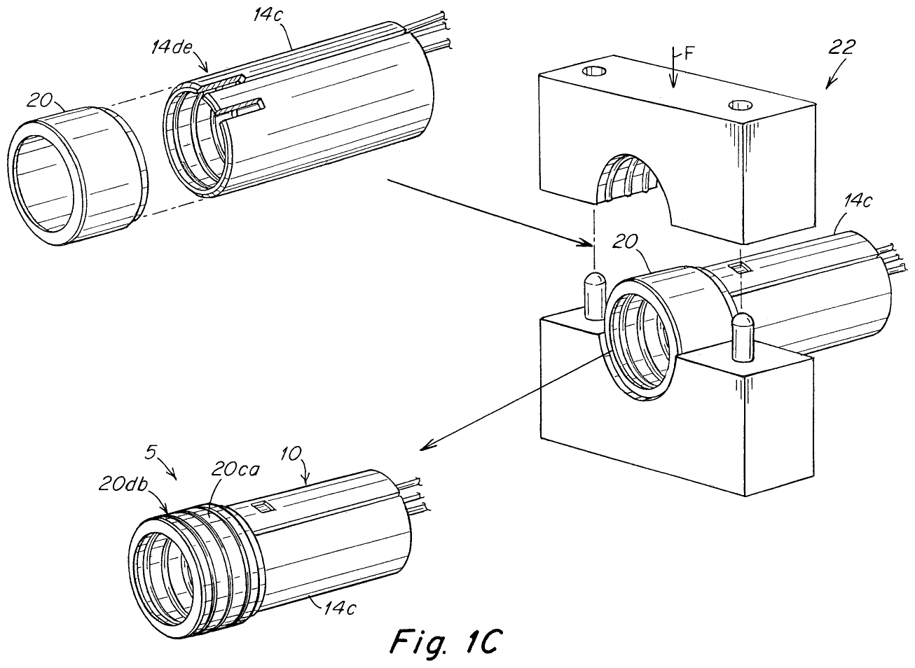

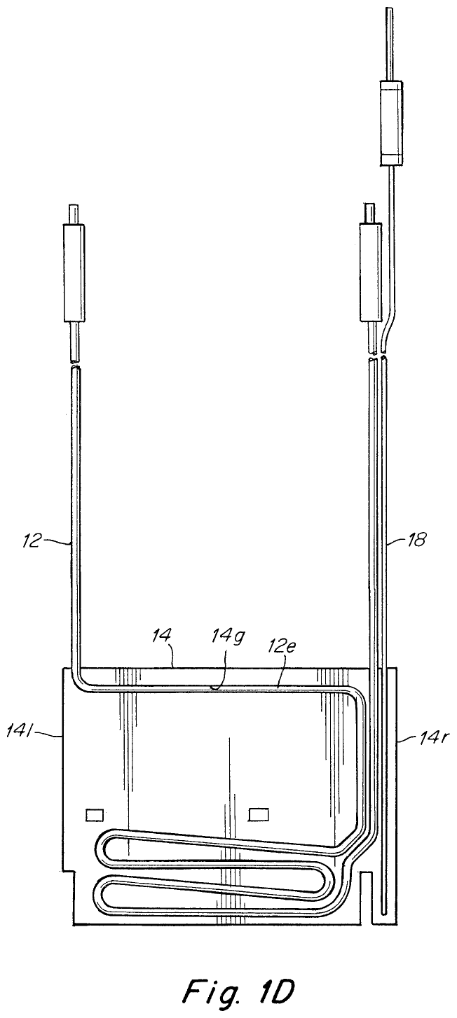

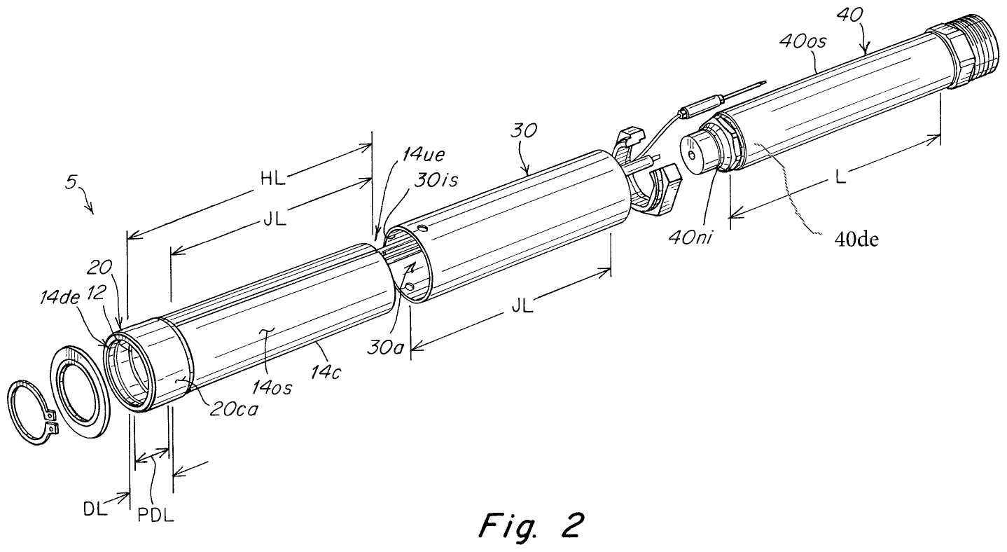

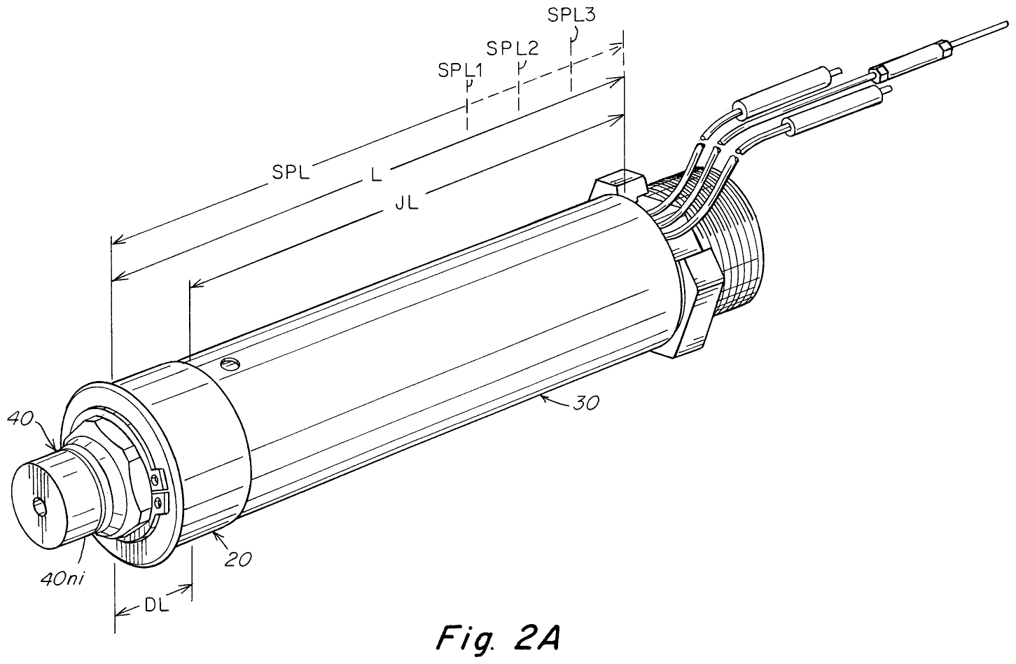

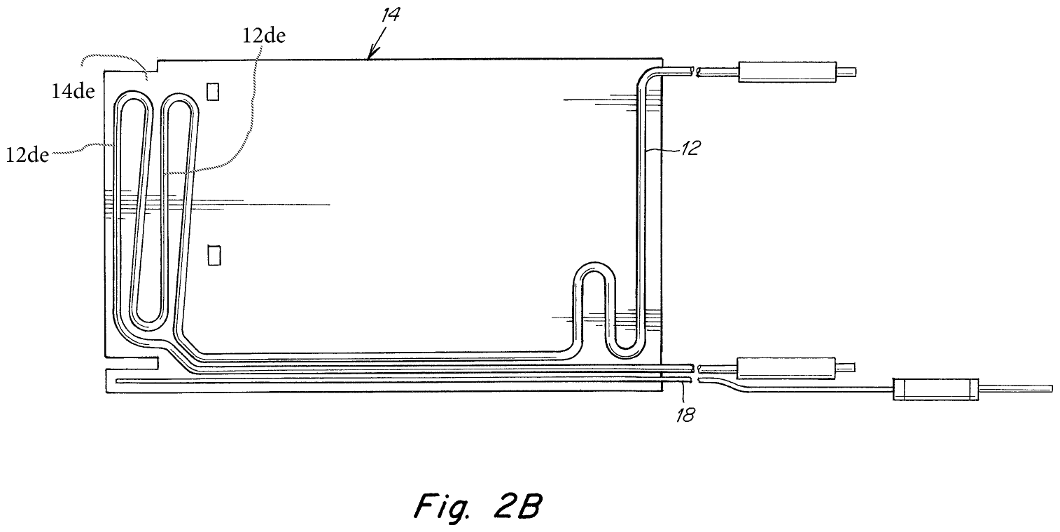

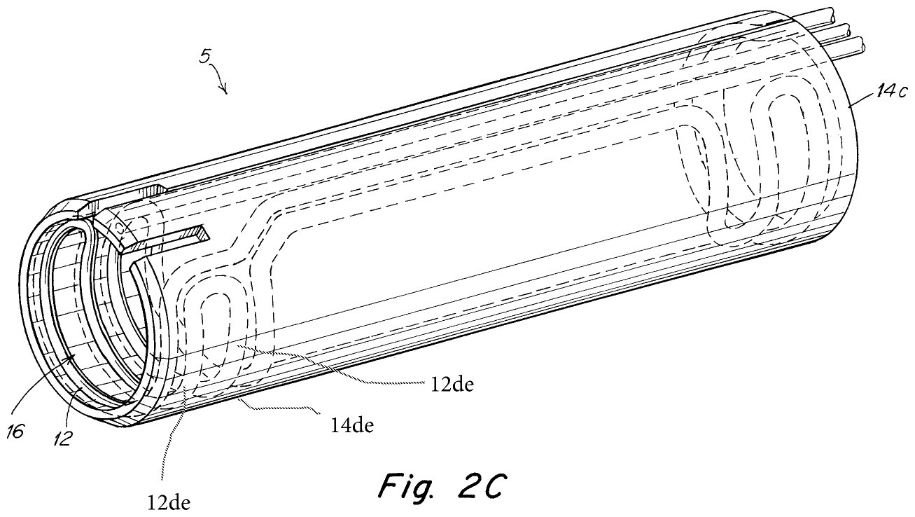

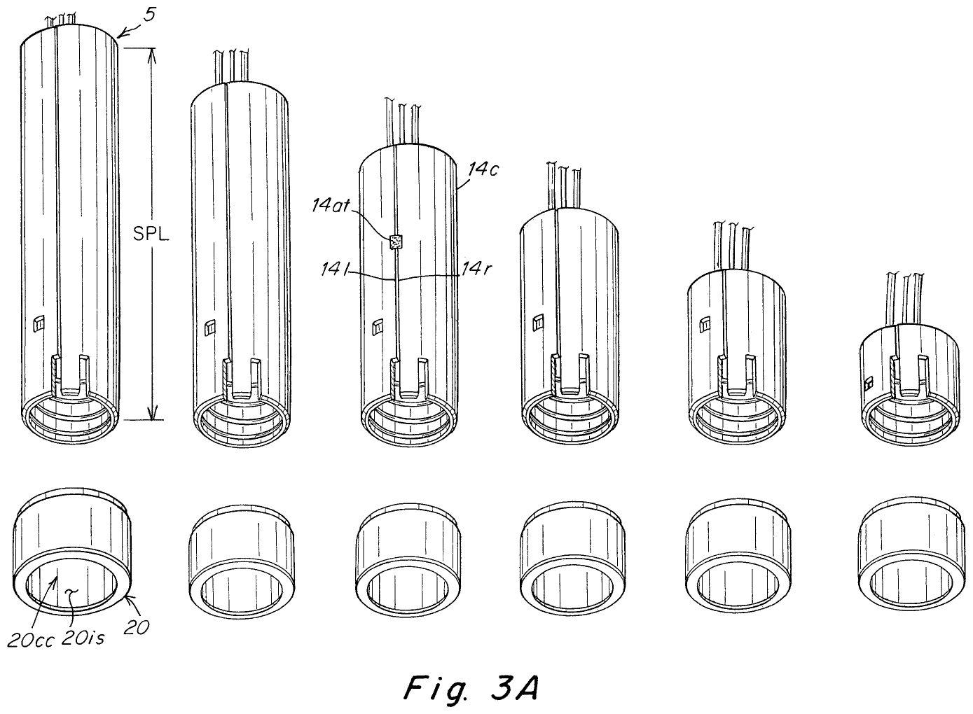

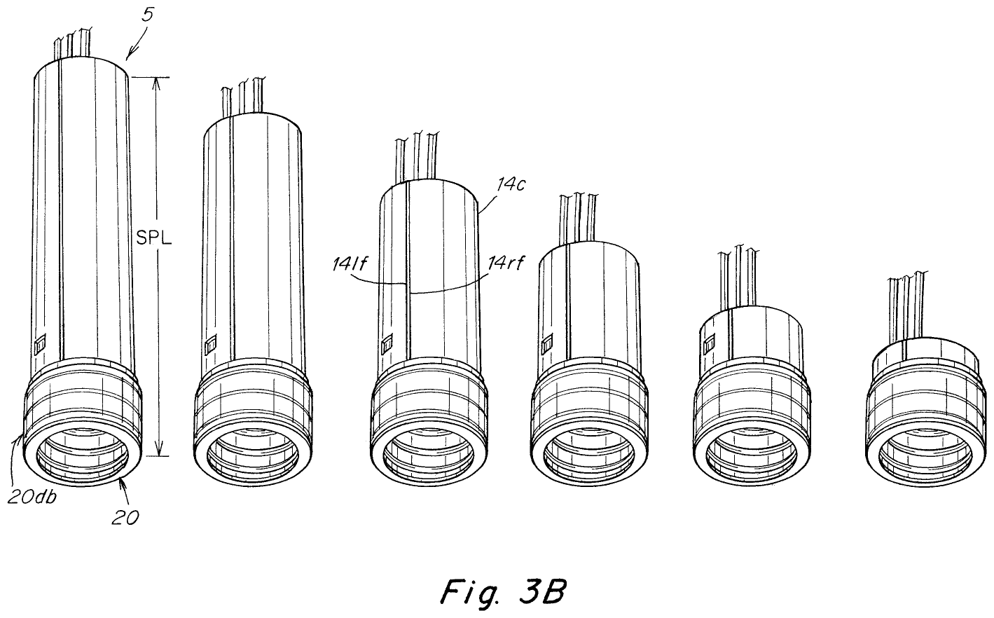

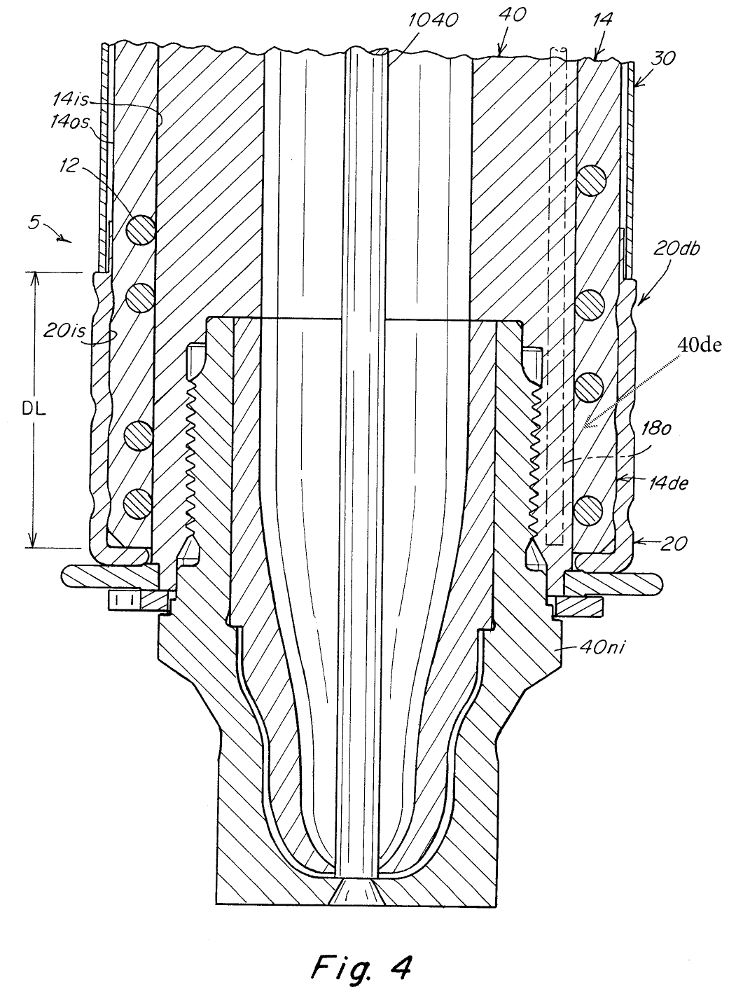

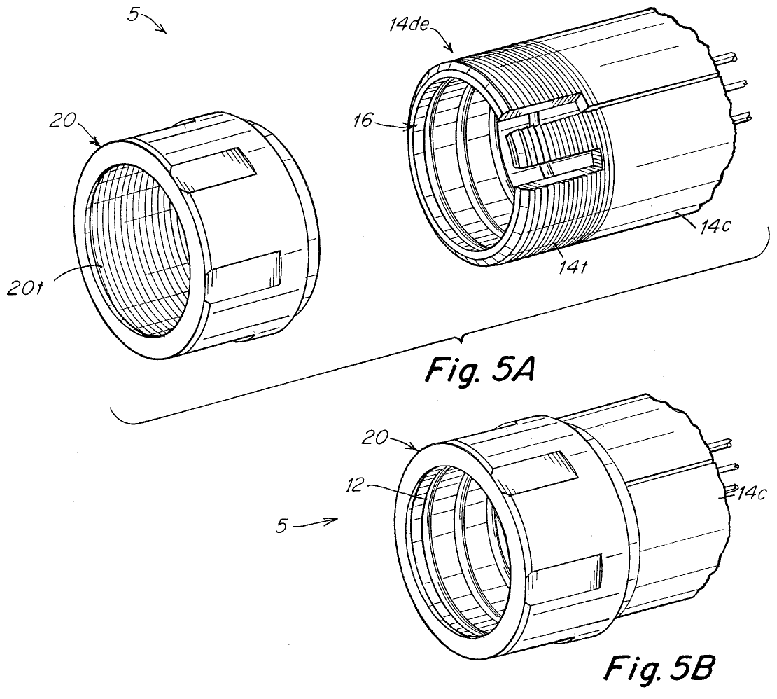

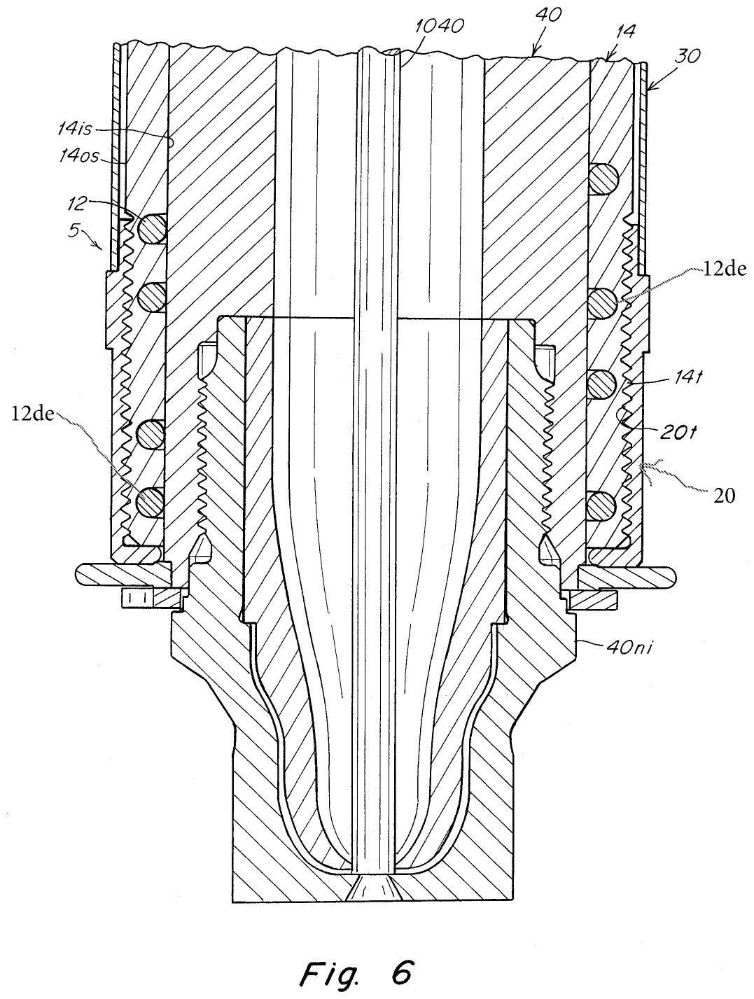

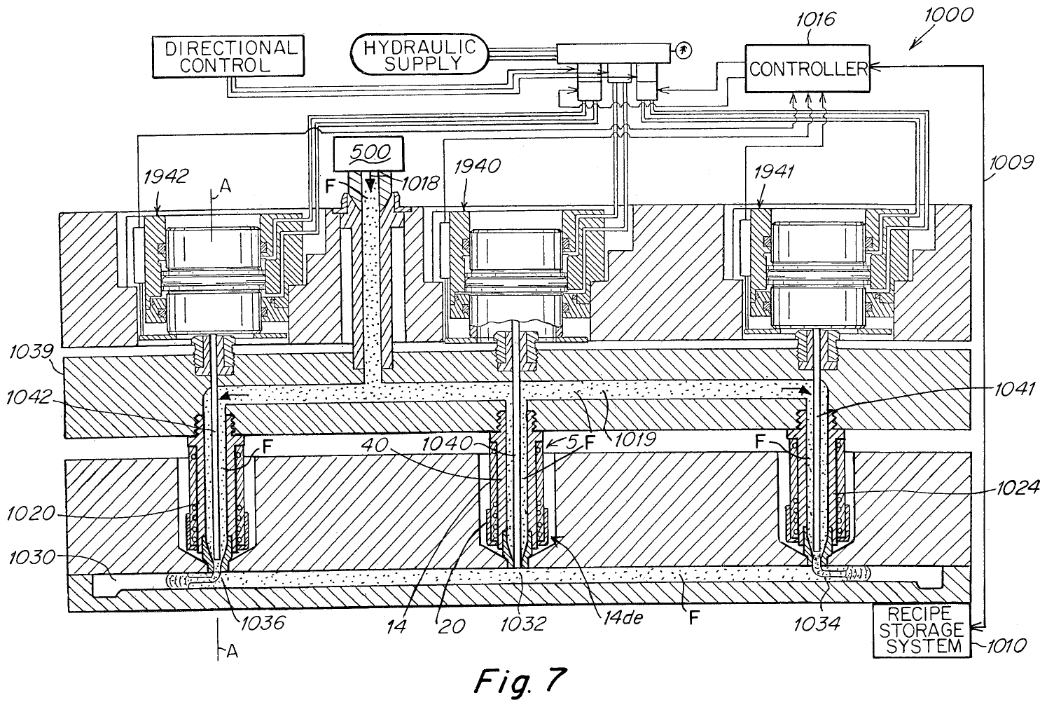

FIG. 1D is a more detailed top view of one of the two opposing sides of the sheet form heating element shown in FIGS. 1A, 1B.

FIG. 2 is an exploded perspective view of a sheet form heating sleeve element as shown in FIGS. 1A, 1B, 1D together with an associated nozzle, a distal end fastening cylinder and main nozzle body fastening jacket.

FIG. 2A is a front perspective view of the FIG. 2 components fully assembled with the heating sleeve or jacket and distal end fastening cylinder fastened together and assembled together with the nozzle body where the heating sleeve has a longitudinal length (HL) that extends the full longitudinal length (L) of the nozzle around the outside circumferential surface (40os) of the nozzle body.

FIG. 2B is a top view of one side or surface of the sheet form heating element of the FIGS. 2, 2A apparatus.

FIG. 2C is a front perspective semi-transparent view of the sheet form heating element and nozzle element of the FIGS. 2, 2A apparatus assembled together showing the arrangement of the heating element circumferentially around the outside surface of the nozzle body element.

FIG. 3A is a top perspective view of a series of sheet form heating sleeve elements of FIG. 1A formed into a series of cylinders having varying longitudinal lengths each with a distal end cylindrical fastener shown distally exploded from the distal downstream ends of the cylindrically formed heating sleeve elements.

FIG. 3B is a figure similar to FIG. 3A showing the distal end cylindrical fasteners fastened to the distal ends of the heating sleeve elements.

FIG. 4 is a side sectional view of the distal end of an injection molding apparatus nozzle comprised of a nozzle body having a heating apparatus similar to the heating apparatuses shown in FIGS. 3A, 3B mounted around at least the distal end of the nozzle.

FIG. 5A is an exploded view of the distal end of a sheet form heating sleeve formed into a cylindrical configuration having a central channel and a threaded distal end complementary to a threaded fastening cylinder for screwable or threaded attachment thereto.

FIG. 5B is a view similar to FIG. 5A showing the components assembled together.

FIG. 6 is a longitudinal sectional view of the distal end of an injection nozzle having a sheet form heating element with heating or thermocouple wires or element wrapped circumferentially around the outside circumferential surface of at least the distal end of the nozzle with a threaded cap element as in FIGS. 5A, 5B screwed onto the distal end of the sheet form heating element and showing a receiving tube element receiving and circumferentially enclosing the subassembly of the nozzle and sheet form heating element.

FIG. 7 is a schematic side sectional view of an injection molding system in which a heating apparatus as described above is incorporated into or onto the downstream nozzle elements of the system.

### DETAILED DESCRIPTION

FIG. 7 illustrates an injection molding system 1000 comprised of an injection molding machine 500 that injects an injection fluid 1018 to a heated manifold 1039 for distribution and downstream injection through one or more nozzles 40, 1020, 1024 into the cavity 1030 of a mold 1002. The system 1000 as shown illustrates one 40 of the several nozzles 40 having a heating apparatus 5 according to the invention mounted to the distal end 14de of the heating sleeve or jacket element 10 of the heating apparatus 5. A controller 1016 cam includes a flow control MCU and a recipe storage system 1010 (with a recipe storage MCU that can be mounted on the mold 1002. In such an embodiment, a recipe of process parameters that are stored on the mold storage device 1010 are transmitted via a communication channel 1009 to the main MCU in controller 1016 for execution. In alternative embodiments the control process parameters included in the mold storage device can be stored or programmed into the memory or instruction components of a controller mounted apart from the mold such as controller 1016

As shown, molten material F is fed from an injection molding machine (500) through a main inlet 1018 to a distribution channel 1019 of a manifold 1039. The distribution channel commonly feeds three separate nozzles 1020, 40, 1024 which all commonly feed into a common cavity 1030 of a mold 1002 to make one molded part. The central nozzle 40 is controlled by actuator 1940 and arranged so as to feed into cavity 1030 at an entrance point or gate that is disposed at about the center 1032 of the cavity. As shown, a pair of lateral nozzles 1020, 1024 feed into the mold cavity 1030 at gate locations that are distal 1034, 1036 to the center gate feed position 1032.

As shown in FIG. 7 the injection cycle is typically a cascade process where injection is effected in a sequence from the center nozzle 40 first and at a later predetermined time from the lateral nozzles 1020, 1024. As shown the injection cycle is typically started by first opening the pin 1040 of the center nozzle 40 and allowing the fluid material F (typically polymer or plastic material) to flow up to a position in the cavity just before 1100b, the distally disposed entrance into the cavity of the lateral nozzle 1024. Once the fluid material has further travelled just past the entrance to nozzle 1024, at position 1100p, the center gate 1032 of the center nozzle 40 is typically closed by pin 1040. The lateral gates 1034, 1036 are then opened by upstream withdrawal of lateral nozzle pins 1041, 1042. The rate of upstream withdrawal or travel velocity of lateral pins 1041, 1042 is typically controlled in a manner to avoid defects in the part that is ultimately produced in the cavity.

In alternative embodiments, the center gate 1032 and associated actuator 1940 and valve pin 1040 can remain open at, during and subsequent to the times that the lateral gates 1034, 1036 are opened such that fluid material flows into cavity 1030 through both the center gate 1032 and one or both of the lateral gates 1034, 1036 simultaneously.

When the lateral gates 1034, 1036 are opened and fluid material F is allowed to first enter the mold cavity into the stream that has been injected from center nozzle 40 past gates 1034, 1036, the two streams mix with each other. If the velocity of the fluid material is too high, such as often occurs when the flow velocity of injection fluid material through gates 1034, 1036 is at maximum, a visible line or defect in the mixing of the two streams will appear in the final cooled molded product at the areas where gates 1034, 1036 inject into the mold cavity. By injecting fluid at a reduced flow rate for a relatively short period of time at the beginning when the gates 1034, 1036 are first opened and following the time when fluid first enters the flow stream the appearance of a visible line or defect in the final molded product can be reduced or eliminated.

The rate or velocity of upstream withdrawal of valve pins 1040, 1041, 1042 starting from the closed position is controlled via controller 1016 or MCU 1010 which controls the rate and direction of flow of hydraulic fluid from a drive system to actuators 1940, 1941, 1942. Although fluid driven actuators are employed in the disclosed embodiments, actuators powered by an electric or electronic motor or drive source can alternatively be used as the actuator component. Another embodiment would have the controller dynamically control the movement of an actuator and associated valve pin in order to meet target pressure profiles based upon (closed loop) feedback received by the controller from a pressure sensor monitoring flow of the fluid material F in the system, upstream of the mold cavity. Yet another embodiment would have the controller trigger the opening and/or closing of an actuator and associated valve pin based upon a sensed pressure or temperature condition within the mold cavity.

FIGS. 1A-1D show a heating sleeve element 10 of a heating apparatus 5 disposed in its flat or sheet form 14 prior to being formed into a cylindrical heating cylinder form 14c. The heating sleeve 10 is comprised of the heating sleeve element 14, 14c which is comprised of a highly thermally conductive material such as brass or copper and includes a heating coil 12 that is disposed in thermally conductive contact with the heating sleeve element 14, 14c. Typically the heating coil 12 comprises a metal electrically conductive and resistive wire to which is applied an electric current that causes the wire or coil to heat up. The electrically heated wire or coil 12 is typically embedded within a complementary groove 14g formed within the body of the heating sleeve element 14, 14c in order to maximize conduction of heat from the heating coil 12 to the material of which the heating sleeve element 14, 14c is comprised. The heated wire or coil 12 can alternatively be mounted to a surface 14os or 14is of the heating cylinder preferably in compressed contact or engagement sufficient to readily enable transfer or conduction of heat from the wire or coil 12 to the highly conductive material of which the heating sleeve element 10 and cylinder 14 is comprised.

FIG. 1C shows an embodiment where the outside circumferential surface of the distal end of the cylindrically formed heating element 14, 14c is smooth or continuous without threads. In such an embodiment a securing ring 20 is compressibly attached or affixed around the circular distal end 14de of the heating element by compressibly crimping or deforming 29db the securing ring 20 with for example a crimping device 22 that exerts a crimping force F such that the inside circumferential surface 20ca of the ring 20 compressibly engages the outer circumferential surface of the distal end 14de and becomes effectively affixed thereto and simultaneously holds or maintains at least the downstream end 14de of the sheet 14 in a cylindrical configuration.

FIGS. 2, 2A, 4 show a nozzle body 40 having an outer circumferential surface 40os over or around which the interior surface 14is of the heating sleeve element 14, 14c is wrapped into thermally conductive engagement such that heat generated in the body of the heating sleeve element 14, 14c is most readily and efficiently conducted to the body of the nozzle 40. In the FIGS. 2, 2A embodiment a retaining cylinder, sleeve or jacket 30 having an extended receiving aperture (30a) having an extended longitudinal length (JL) and interior extended jacket surface (30is) is employed to circumferentially enclose or house the subassembly of the heating element 14 and nozzle 40. The upstream sleeve or jacket 30 is adapted to receive the upstream end or portion 14ue of the heater cylinder 14c along the extended longitudinal length JL. The upstream sleeve or jacket (30) is also adapted such that the interior extended jacket surface 30is engages the outer circumferential surface 14os of the upstream end or portion 14ue of the heater cylinder 14c.

FIG. 2B shows the heating element 14 in its initial flat sheet form with the heating element 12 disposed or arranged on the area of the sheet 14 in a predetermined configuration such that the heating element is disposed in contact with the distal end 14de in a concentrated heat configuration. 12de.

FIGS. 5A, 5B, 6 show an embodiment where the interior surface of the distal end cap or ring 20 is provided with threads 20t and the outside surface 14os of the distal end 14de of the heating element is provided with complementary threads 14t that enable the retaining ring 20 to be screwably engaged onto or around the distal end 14de.

What is claimed is:

1. A heating apparatus in an injection molding apparatus comprised of an injection molding machine that injects injection fluid to a heated manifold that distributes the injection fluid to one or downstream nozzles, the heating apparatus comprising:
a heatable sleeve or jacket comprised of a sheet of highly heat conductive metal material, the sheet or jacket having opposing sheet edges, the sheet or jacket being bendable or formable into a heating cylinder having a central channel having an interior circumferential wall surface and a selected longitudinal length (JL) extending from a downstream end to an upstream end of the heating cylinder,
the central channel being formed into a configuration wherein a selected nozzle is received within the central channel and the interior circumferential wall surface of the channel engages an outer circumferential wall surface of the selected nozzle,
the sheet having opposing sheet edges that are disposed in a select arrangement or position relative to each other upon bending or forming of the sheet into the cylinder and reception of the selected nozzle within the central channel,
a stabilization ring or cylinder having a central ring channel having an inner ring circumferential surface, the stabilization ring or cylinder being adapted to receive a selected longitudinal portion (DL) of the downstream or distal end of the heating cylinder,
the stabilization ring or cylinder being adapted to engage or mate the inner ring circumferential surface with an outer surface of the heating cylinder extending along the selected longitudinal portion (DL) of the downstream or distal end of the heating cylinder.

2. The apparatus of claim 1 further comprising a wire or coil that is controllably heatable to an elevated temperature and that is mounted in heat conductive communication with the heating cylinder.

3. The apparatus of claim 1 wherein the highly heat conductive metal material comprises one or more of a copper, brass, zinc.

4. The apparatus of claim 1 wherein the highly heat conductive metal material comprises at least about 90% by weight of one or more of or a mixture of one or more of brass, copper and zinc.

5. The apparatus of claim 1 wherein the wire or coil is embedded within a groove formed within the heating cylinder.

6. The apparatus of claim 1 wherein a temperature measuring sensor is mounted on the downstream or distal end of the heating cylinder in thermal isolation from the wire or coil.

7. The apparatus of claim 1 wherein the opposing sheet edges are interconnected or attached to each other after formation of the heating cylinder.

8. The apparatus of any of the foregoing claims wherein the opposing sheet edges are unconnected or unattached once the heating cylinder is formed.

9. The apparatus of claim 1 further comprising an upstream sleeve or jacket having an extended receiving aperture having an extended longitudinal length (JL) and interior extended jacket surface, the upstream sleeve or jacket being adapted to receive an upstream end or portion of the heater cylinder along the extended longitudinal length (JL), the upstream sleeve or jacket being further adapted such that the interior extended jacket surface engages an outer circumferential surface of the upstream end or portion of the heater cylinder.

10. The apparatus of claim 1 wherein the stabilization ring or cylinder is adapted to be compressed (F) around an outer circumferential surface into a fixedly formed or deformed body having a body size that is preselected such that the inner circumferential surface of the stabilization ring or cylinder is compressibly engaged with the outer circumferential surface of the downstream or distal end of the heating cylinder.

11. The apparatus of claim 1 wherein the inner circumferential ring surface and the outer circumferential surface extending along at least a portion of the downstream or distal longitudinal length (DL) of the downstream or distal end of the heater cylinder have complementary threads adapted to threadably engage and interconnect with each other.

12. The apparatus of claim 1 wherein the stabilization ring or cylinder is comprised of an iron containing metal material.

13. The apparatus of claim 12 wherein the stabilization ring or cylinder is comprised of at least about 95% steel or iron.

14. The apparatus of claim 1 further comprising a temperature measuring sensor mounted on or in the nozzle or a nozzle mount in close adjacency to the outer surface of the downstream or distal end of the heater cylinder.

15. A method of heating a distal end of an injection nozzle in an injection molding apparatus comprising disposing the heating apparatus of claim 1 around the distal end of the nozzle.

16. A heating apparatus in an injection molding apparatus comprised of an injection molding machine that injects injection fluid to a heated manifold that distributes the injection fluid to one or downstream nozzles, the heating apparatus comprising:
a heatable sleeve or jacket comprised of a sheet of highly heat conductive metal material, the sheet or jacket having opposing sheet edges, the sheet or jacket being bendable or formable into a heating cylinder having a central channel having an interior circumferential wall surface and a selected longitudinal length (JL) extending from a downstream end to an upstream end of the heating cylinder,
the central channel being formed into a configuration wherein a selected nozzle is received within the central channel and the interior circumferential wall surface of the channel engages an outer circumferential wall surface of the selected nozzle,
the sheet having opposing sheet edges that are disposed in a select arrangement or position relative to each other upon bending or forming of the sheet into the cylinder and reception of the selected nozzle within the central channel,
a stabilization ring or cylinder having a central ring channel having an inner ring circumferential surface, the stabilization ring or cylinder being adapted to receive a selected longitudinal portion (DL) of the downstream or distal end of the heating cylinder,
the stabilization ring or cylinder being adapted to engage the inner ring circumferential surface around an outer circumferential surface of the heating cylinder extending along a predetermined length (PDL) of all or a portion of the selected longitudinal portion (DL) that is selected such that the opposing sheet edges are held in fixed position relative to each other along at least a selected portion (SPL, SPL1, SPL2, SPL3) of the longitudinal length (HL) of the heating cylinder extending from the downstream end toward the upstream end.

17. The apparatus of claim 16 wherein the predetermined length (PDL) of all or a portion of the selected longitudinal portion (DL) is selected such that the opposing sheet edges are held disconnected or unattached in fixed position relative to each other along at least the selected portion (SPL, SPL1, SPL2, SPL3) of the longitudinal length (HL) of the heating cylinder extending from the downstream end toward the upstream end.

18. The apparatus of claim 16 wherein the longitudinal length of the selected longitudinal portion (DL) of the downstream or distal end of the heating cylinder is selected such that the opposing sheet edges are held disconnected or unattached in the fixed position relative to each other along the entire longitudinal length (HL) of the heating cylinder.

19. The apparatus of claim 16 further comprising a wire or coil that is controllably heatable to an elevated temperature and that is mounted in heat conductive communication with the heating cylinder.

20. The apparatus of claim 16 wherein the wire or coil is embedded within a groove formed within the heating cylinder.

21. The apparatus of claim 16 further comprising a temperature measuring sensor mounted on the downstream or distal end of the heating cylinder in thermal isolation from the wire or coil.

22. The apparatus of claim 16 wherein the opposing sheet edges are interconnected or attached to each other after formation of the heating cylinder.

23. The apparatus of claim 16 wherein the attachment mechanisms comprise one or more of a clasp, a wire, a weld and a clip.

24. The apparatus of claim 16 further comprising an upstream sleeve or jacket having an extended receiving aperture having an extended longitudinal length (JL) and interior extended jacket surface, the upstream sleeve or jacket being adapted to receive an upstream end or portion of the heater cylinder along the extended longitudinal length (JL), the upstream sleeve or jacket being further adapted such that the interior extended jacket surface engages an outer circumferential surface of the upstream end or portion of the heater cylinder.

25. The apparatus of claim 16 wherein the stabilization ring or cylinder is adapted to be compressed (F) around an outer circumferential surface into a fixedly formed or deformed body having a body size such that the inner circumferential surface of the stabilization ring or cylinder is compressibly engaged with the outer circumferential surface of the downstream or distal end of the heating cylinder.

26. The apparatus of claim 16 wherein the inner circumferential ring surface and the outer circumferential surface extending along at least a portion of the downstream or distal longitudinal length (DL) of the downstream or distal end of the heater cylinder have complementary threads adapted to threadably engage and interconnect with each other.

27. The apparatus of claim 16 wherein the stabilization ring or cylinder comprises an iron containing material.

28. The apparatus of claim 16 further comprising a temperature measuring sensor mounted on or in the nozzle or a nozzle mount in close adjacency to the outer surface of the downstream or distal end of the heater cylinder.
